(19) United States
(12) Patent Application Publication
(10) Pub. No.: US 2012/0086223 A1
(43) Pub. Date: Apr. 12, 2012

(54) Tilt-In Window Holder

(76) Inventor: Stephen Golden, Troy, NY (US)

(21) Appl. No.: 12/901,471

(22) Filed: Oct. 8, 2010

(51) Int. Cl. E05C 19/00

(52) U.S. Cl. 292/303; 292/304

(57) ABSTRACT

A device for supporting in an open position a tilting platform, such as a shelf or window, movably connected to a frame, said device comprising a unitary structure having a platform-contacting portion and an anchor portion, wherein the platform-contacting portion and the anchor portion are connected to form a fixed angle between the portions or are movably connected to one another such that the connection of the portions forms an adjustable angle between the portions.

### BACKGROUND

This invention provides a device for holding tilt-in windows and similar moving platforms in which a person needs to temporarily hold the window/platform in a position other than within the normal fame or casing of the window/platform. The device can be used to temporarily hold, for example, tilt-in windows to allow for easier cleaning of the surfaces that are not exposed to the person when the window is in its normal position secured within the casing. The device of this invention is an improvement on prior devices for holding tilting windows, such as poles or hooks or chains, in that it is designed to be temporarily secured directly to the window, can be easily manipulated, and is storable.

### SUMMARY OF THE INVENTION

The subject invention provides a device for supporting in an open position a tilting platform movably connected to a frame. In one embodiment the device comprises a unitary structure having a platform-contacting portion and an anchor portion, said platform-contacting portion having at least two side edges and two end edges and said anchor portion having at least two side edges and two end edges, wherein at least one end edge of said platform-contacting portion is connected to at least one edge of said anchor portion, the connection of the portions forming a fixed angle between the portions. As used herein, the term “platform” refers to any material shaped to form a substantially rigid surface. As used herein, the term “substantially rigid” means that the material would not collapse due to its own weight or additional weight placed upon it when tilted from the frame. Platforms as understood herein may comprise any material such as plastics, woods, metals, glass, fibers and the like including or combinations thereof. As used herein, the term “tilting” refers to the movement of the platform relative to the frame

In certain embodiments, at least a portion of the device comprises plastic, plastic composites, light weight metal materials, or a combination thereof. Examples include high density polyethylene, polyvinylchloride and polypropylene.

In certain embodiments, the device further comprises a support portion contacting both the platform-contacting portion and the anchor portion. In certain embodiments, the support potion contacts the platform-contacting portion at the bottom surface of the platform-contacting portion. In certain embodiments, the support potion contacts the anchor portion at the bottom surface of the anchor portion. In certain embodiments, the platform-contacting portion, anchor portion and support portion form a generally triangular shape to the device.

In certain embodiments, the platform contacting portion comprises at least two opposing caliper elements, said caliper elements being spaced apart so as to form a recess in the device for engaging the platform within the recess. In certain embodiments the caliper elements are set in a fixed position relative to one another. In certain embodiments, at least one of the caliper elements is movably connected to the device such that the space between said caliper elements, i.e, the recess formed by the calipers, is adjustable. Allowing for the adjustment of the caliper elements allows for the device to engage different size platforms. Various means for movably connecting such caliper elements to one another will be readily apparent to those of skill in the art. Such means include, but are not limited to, a hinge or a spring or a combination thereof. Depending on the material from which the device is constructed, a hinge, for example, could be fashioned as a separate piece, made of the same or a different material as the device, and later connected to the device. Alternatively, a hinge could be incorporated in the material from which the device is made, such as where the device is made of a plastic or moldable resin and the hinge is fashioned by crimping the material at a point to form a fulcrum or pivot element. In an alternative embodiment, a spring element can also be fashioned from the same or different material as the device and incorporated into the device. In certain embodiments, the device further comprises means for holding said at least one movable caliper element in a fixed position. Various means for holding the caliper at least a portion of such movement being in the vertical direction. Thus, the device of the subject invention provides a hands free support for the platform, restricting movement of the platform in a vertical direction by virtue of the device engaging the platform.

In certain embodiments of the invention, the platform-contacting portion of the device comprises a generally rectangular shape having a top surface and a bottom surface, wherein the top surface comes in contact with the tilting platform.

In certain embodiments of the invention, the anchor portion comprises a generally rectangular shape having a top surface and a bottom surface, wherein the top surface comes in contact with a second surface other than the tilting platform, thereby immobilizing the device between the platform and said second surface. The angle formed between the portions is between approximately 45° and approximately 120°. In equally preferred embodiments, the angle formed between the portions is between approximately 55° and approximately 115°, between approximately 65° and approximately 110°, between approximately 75° and approximately 100°, between approximately 85° and approximately 105°, or between approximately 90° and approximately 100°. In certain embodiments, the angle formed between the portions is approximately 90°.

In certain embodiments of the invention the platform comprises a shelf or a window. As used herein “window” includes, but is not limited to, glass panes immobilized within a casing attached to a frame, whereby the frame allows for the moving of the window relative to the frame, while the window is still connected to the frame. Various examples of such windows are known to those in the art and include Pella Windows (Pella, Iowa, USA), Anderson Windows (Bayport, Minn., USA), American Craftsman (USA), and Castle Windows (Mt Laurel, N.J., USA). Such windows are typically installed in walls within new and older constructed buildings. The ability of the windows to tilt within the frame allows for access to both sides of the window, for example to allow cleaning or repair of the side of the window opposite the user. elements in a fixed position will be readily apparent to those of skill in the art. Such means include, but are not limited to, a locking mechanism such as a hole and peg combination or Velcro closure mechanism.

In certain embodiments, at least one of the top surface of the platform-contacting portion and the top surface of the anchor portion comprises a non-stick surface. Means for creating non-stick surfaces are known to those of skill in the art and include, but are not limited to, incorporating foam, rubber, adhesive or some combination thereof to the surface.

The subject invention also provides a device for supporting in an open position a tilting platform connected to a frame, said device comprising a unitary structure having a platform contacting portion and an anchor portion, said platform contacting portion having at least two side edges and two end edges and said anchor portion having at least two side edges and at least two end edges, wherein at least one end edge of said platform contacting portion is movably connected to at least one edge of said anchor portion, the connection of the portions forming a means to adjust the angle between the portions. Various means for movably connecting the platform contacting portion and the anchor portion will be apparent to those in the art. For example, in certain embodiments, the platform contacting portion is connected to the anchor portion by a hinge. In certain embodiments, the platform contacting portion is connected to the anchor portion by a spring. Depending on the material from which the device is constructed, a hinge, for example, could be fashioned as a separate piece, made of the same or a different material as the device, and later connected to the device. Alternatively, a hinge could be incorporated in the material from which the device is made, such as where the device is made of a plastic or moldable resin and the hinge is fashioned by crimping the material at a point to form a fulcrum or pivot element. In an alternative embodiment, a spring element can also be fashioned from the same or different material as the device and incorporated into the device.

In certain embodiments, the device further comprises means for adjusting the angle between the portions. For example, the device may comprise a support portion contacting both the platform contacting portion and the anchor portion and further comprising a means for varying the length of the support portion. In certain embodiments, this type of support portion comprises at least two pieces and said means for varying the length of the support portion typically comprises a means for securing said two pieces at various points along the length of the pieces. Various means for securing the two pieces are readily apparent to those of skill in the art, and include, but are not limited to Velcro closure, straps, bands or a combination thereof. In certain embodiments, the means for securing said at least two pieces may comprise holes on one piece and corresponding pegs on at least one other piece. In certain embodiments, at least one end of each piece of the support portion may have a threaded surface. In such embodiments, the device may further comprise a connector portion contacting the threaded surfaces of each piece, whereby manipulation of said connector portion results in said threaded ends of said pieces moving relative to one another. Said movement relative to one another allows for the entire support portion (made up of the movable pieces) to elongate or contract in length.

### BRIEF DESCRIPTION OF THE FIGURES

FIGS. 1A, 1B, and 1C depict an embodiment of the claimed invention from side elevation (1A), front elevation (1B), and rear elevation (1C).

FIG. 2 depicts a plan view showing an embodiment of the invention used to support a tilting platform.

FIG. 3 depicts a perspective view showing an embodiment of the invention used to support a window.

FIG. 4 depicts an embodiment of the invention showing a means for adjusting the angle between the platform contacting portion and the anchor portion.

FIG. 5 depicts an embodiment of the invention showing a means for adjusting the space between the caliper elements of the platform contacting portion.

### DETAILED DESCRIPTION

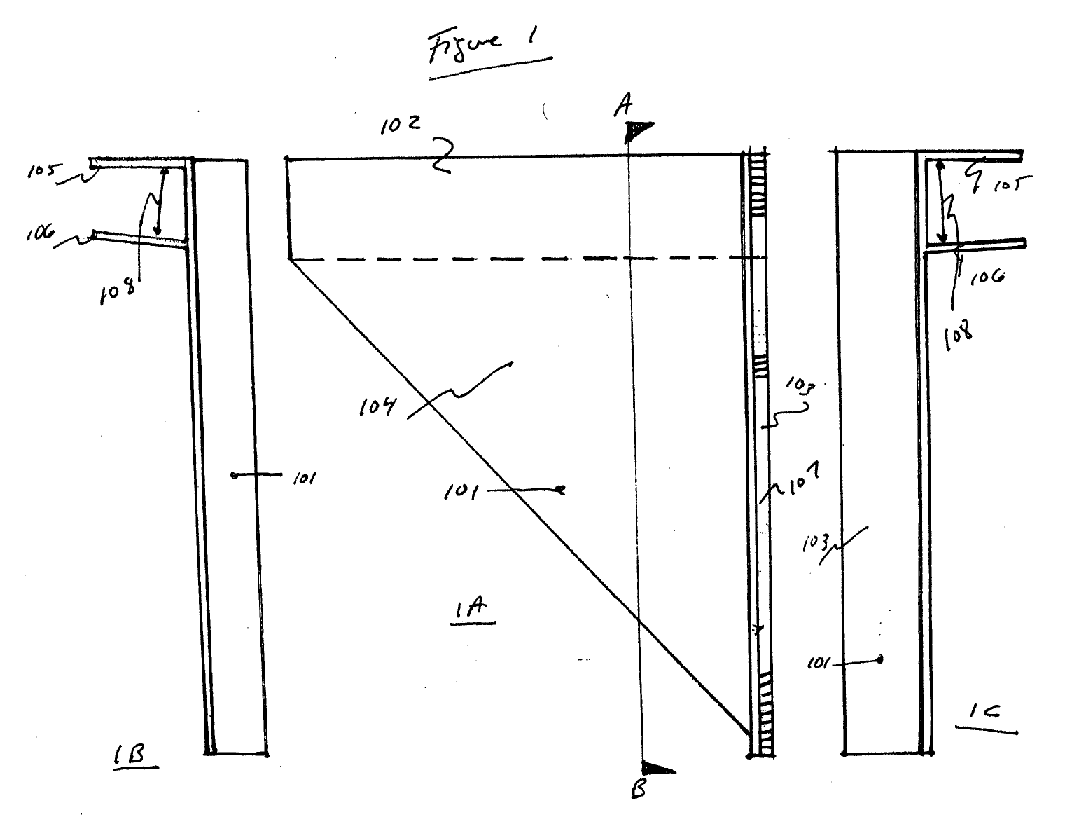

Certain embodiments of the subject invention will now be described in more detail by reference to the attached figures. As depicted in FIG. 1, an embodiment of the device of the invention 101 is shown comprising platform contacting portion 102 and anchor portion 103, with optional support portion 104. In FIG. 1B, device 101 is shown from the right side revealing detail of this embodiment, wherein platform contacting portion 102 comprises optional caliper elements 105 and 106. FIG. 1C depicts this embodiment from the left side, revealing caliper elements 105 and 106 and showing anchor portion 103. In FIG. 1A, anchor portion 103 further comprises optional non-stick surface 107. In FIGS. 1B and 1C, recess 108 is depicted as formed from the positioning of caliper elements 105 and 106.

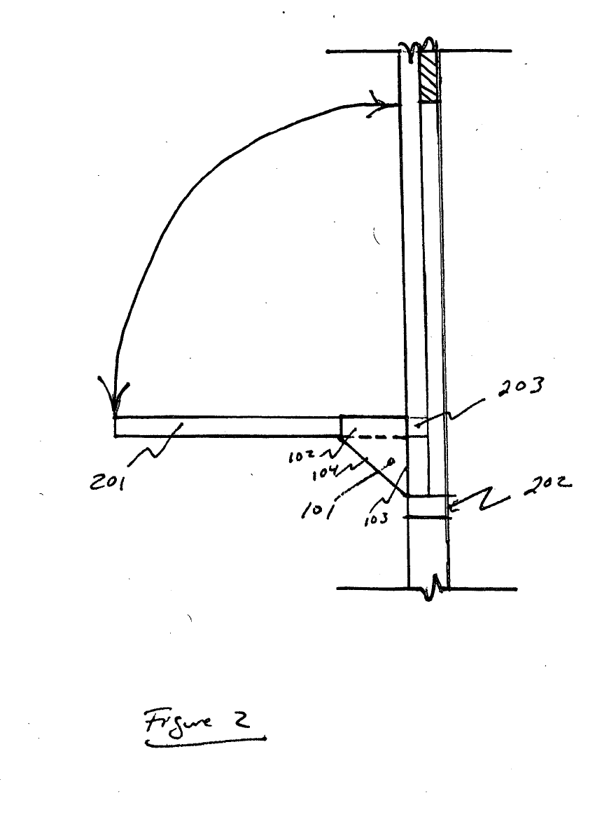

As depicted in FIG. 2, a plan view is shown wherein an embodiment of the device of the invention 101 used to support a tilting platform 201. As shown in this embodiment, platform 201 engages device 101 at platform contacting portion 102. Platform 201 is connected to frame 202 at connecting point 203, which can be a hinge or other pivot means. Optional support portion 104 is depicted between platform contacting portion 102 and anchor portion 103. Device 101, which contacts platform 201, also contacts frame 202 at anchor portion 103, thereby supporting and substantially immobilizing platform 201 in an “open” position.

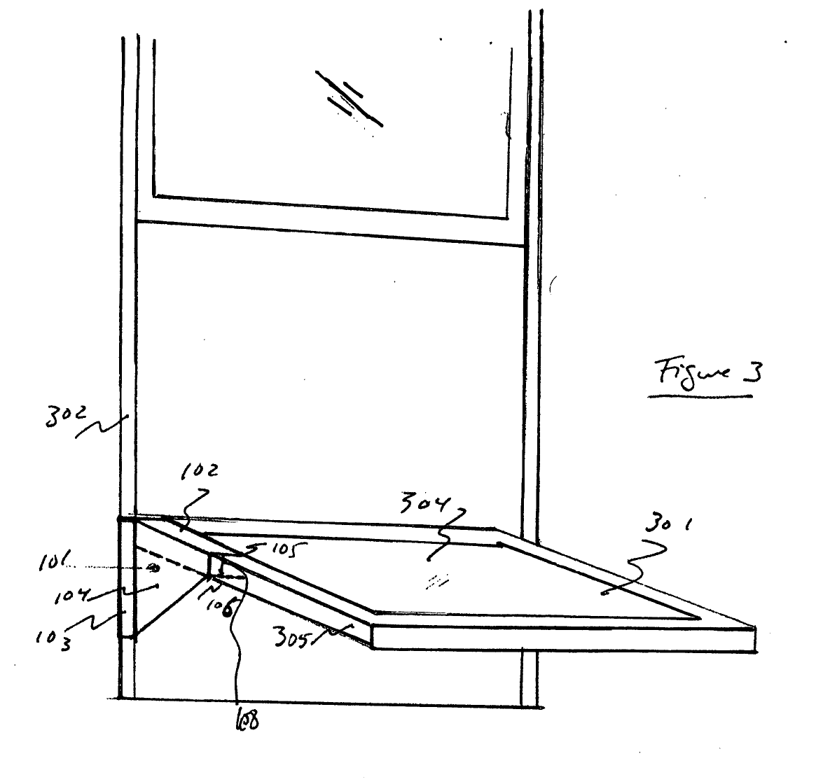

As depicted in FIG. 3, a perspective view is shown wherein an embodiment of the device of the invention 101 used to support a tilting platform, which can be a tilting window 301. As shown in this embodiment, window 301 engages device 101 at platform contacting portion 102. Window 301 is connected to frame 302 and may comprise glass 304 immobilized within casing 305. As used herein, the term “frame” also is referred to as the window jamb and the term “casing” is also known as the window sash. In this embodiment of device 101, platform contacting portion 102 comprises caliper portions 105 and 106, forming recess 108. Optional support portion 104 is depicted between platform contacting portion 102 and anchor portion 103. Window 301 contacts platform contacting portion 102 by insertion of window casing 305 within recess 108. Device 101, which contacts window 301, also contacts frame 302 at anchor portion 103, thereby supporting and substantially immobilizing window 301 in an “open” position.

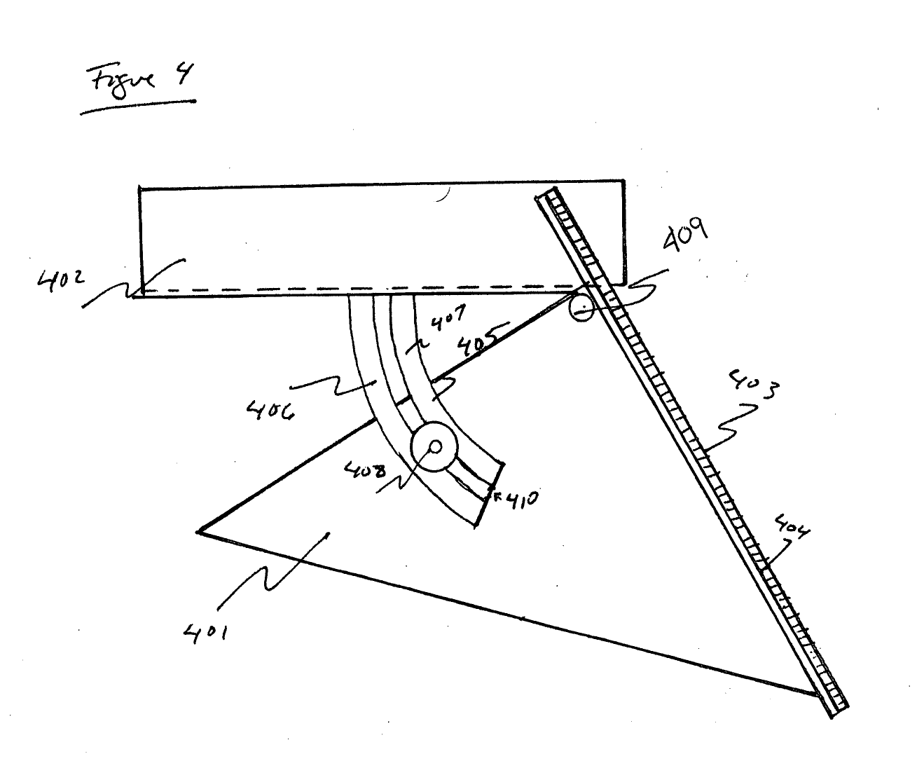

As depicted in FIG. 4, an embodiment of the device of the invention 401 depicting platform contacting portion 401 and anchor portion 403. Anchor portion 403 contains optional no-slip coating 404. Device 401 further comprises adjusting means 405 for adjusting the angle between the platform contacting portion 402 and anchor portion 403. In this embodiment, adjusting means 405 comprises arms 406 and 407 fixedly connected to the platform contacting portion and restricting means 408. Platform contacting portion 402 and anchor portion 403 are connected at pivot element 409. Arms 406 and 407 are spaced apart at an interval 410 that allows for restricting means 408 to engage arms 406 and 407 and restrict pivot of platform contacting portion 402 and anchor portion 403 around pivot element 409, thereby controlling the angle between platform contacting portion 402 and anchor portion 403. Unseen in this depiction, restricting means 408 may comprise a screwing mechanism that allows for the adjustment of restricting means 408 relative to anchor portion 403, such that arms 406 and 407 are held in place against anchor portion 403 as restricting means 408 is turned.

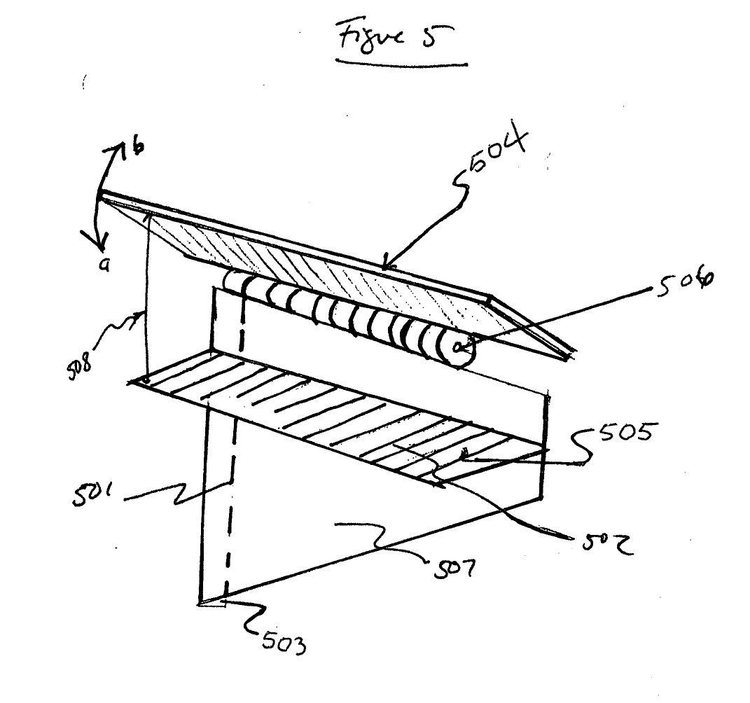

As depicted in FIG. 5, an embodiment of the device of the invention 501 is shown depicting platform contacting portion 502 and anchor portion 503 connected by support portion 507. Platform contacting portion 502 further comprises caliper elements 504 and 505 defining recess 508 between them. Device 501 is depicted containing optional adjusting means 506 for adjusting the space between the caliper elements 504 and 505 such that at least caliper element 504 is able to move between positions a and b, thereby adjusting the size of recess 508. Adjusting means 506 may comprise a hinge or spring element that provides tension such that force is required to move caliper element 504 between position a to position b. In such an embodiment, adjusting means 506 provides for a restrictive force on caliper elements 504 and 505, creating a means for restricting a platform within recess 508, such as by friction. In this manner device 501 may be secured to a platform contacting device 501 within recess 508 while contacting a frame to which the platform is connected at anchor portion 503, thereby supporting and substantially immobilizing said platform in an “open” position.

Several example embodiments of the present invention are specifically illustrated and described herein. However, it will be appreciated that modifications and variations of the present invention are covered by the above teachings and within the purview of the appended claims without departing from the spirit and intended scope of the invention.

1. A device for supporting in an open position a tilting platform movably connected to a frame, said device comprising a unitary structure having a platform-contacting portion and an anchor portion, said platform-contacting portion having at least two side edges and two end edges and said anchor portion having at least two side edges and two end edges, wherein at least one end edge of said platform-contacting portion is connected to at least one edge of said anchor portion, the connection of the portions forming a fixed angle between the portions.

2. The device of claim 1, wherein the platform-contacting portion comprises a generally rectangular shape having a top surface and a bottom surface, wherein the top surface comes in contact with the tilting platform.

3. The device of claim 1, wherein the anchor portion comprises a generally rectangular shape having a top surface and a bottom surface, wherein the top surface comes in contact with a second surface other than the tilting platform, thereby immobilizing the device between the platform and said second surface.

4. The device of claim 1, wherein the angle formed between the portions is between approximately 45° and approximately 120°.

5. (canceled)

6. (canceled)

7. (canceled)

8. The device of claim 1, wherein the angle formed between the portions is between approximately 85° and approximately 105°.

9. (canceled)

10. The device of claim 1, wherein the angle formed between the portions is approximately 90°.

11. The device of claim 1, wherein the platform comprises a window.

12. (canceled)

13. The device of claim 1 further comprising a support portion contacting both the platform-contacting portion and the anchor portion.

14. (canceled)

15. (canceled)

16. The device of claim 13, wherein the platform-contacting portion, anchor portion and support portion form a generally triangular shape.

17. The device of claim 1 wherein the platform contacting portion comprises at least two opposing caliper elements, said caliper elements spaced apart so as to form a recess in the device for engaging the platform within the recess.

18. The device of claim 17, wherein the caliper elements are set in a fixed position relative to one another.

19. The device of claim 17, wherein at least one of the caliper elements is movable connected to the device such that the space between said caliper elements is adjustable.

20. The device of claim 19, wherein at least one of the caliper elements is connected to the device by a hinge.

21. The device of claim 19, wherein at least one of the caliper elements is connected to the device by a spring.

22. (canceled)

23. The device of claim 1, wherein at least one of the top surface of the platform-contacting portion and the top surface of the anchor portion comprises a non-stick surface.

24. (canceled)

25. A device for supporting in an open position a tilting platform connected to a frame, said device comprising a unitary structure having a platform contacting portion and an anchor portion, said platform contacting portion having at least two side edges and two end edges and said anchor portion having at least two side edges and at least two end edges, wherein at least one end edge of said platform contacting portion is movably connected to at least one edge of said anchor portion, the connection of the portions forming an adjustable angle between the portions.

26. (canceled)

27. (canceled)

28. The device of claims 25 further comprising means for adjusting the angle between the portions.

29. The device of claim 28, wherein said means for adjusting the angle between the portions comprises a support portion contacting both the platform contacting portion and the anchor portion and further comprising a means for varying the length of the support portion.

30. (canceled)

31. (canceled)

32. (canceled)

33. (canceled)

34. (canceled)

35. The device of claim 25, further comprising a securing means for securing the platform contacting portion to a platform.

36. The device of claim 25, wherein the platform contacting portion comprises at least two opposing caliper elements, said caliper elements spaced apart so as to form a recess in the device for engaging the platform within the recess.

37. (canceled)

38. (canceled)

39. (canceled)

40. (canceled)

41. (canceled)

42. (canceled)

43. (canceled)

44. (canceled)
